(19) United States
(12) Patent Application Publication
(10) Pub. No.: US 2026/0236517 A1
(43) Pub. Date: Aug. 13, 2026

(54) METHOD AND RELATED DEVICE FOR IMPLEMENTING INTELLIGENT CONVERSATION REVERSE QUESTION CLARIFICATION

(71) Applicant: Beijing Volcano Engine Technology Co., Ltd., Beijing (CN)

(72) Inventors: Jun HENG, Beijing (CN); Yingchun ZOU, Beijing (CN); Xiaoming ZHAO, Beijing (CN)

(21) Appl. No.: 19/538,377

(22) Filed: Feb. 12, 2026

(30) Foreign Application Priority Data
Feb. 13, 2025 (CN) 202510162064.X

(51) Int. Cl. G06F 16/338; G06F 16/3329; G06F 16/951; G06F 40/284

(52) U.S. Cl. CPC G06F 16/338; G06F 16/3329; G06F 16/951; G06F 40/284

(57) ABSTRACT

The present disclosure provides a method for implementing intelligent conversation reverse question clarification, comprising: receiving a query sentence input by a user; identifying key information to be clarified in the query sentence based on a preset candidate indicator set, and determining a candidate indicator corresponding to the key information to be clarified; outputting the query sentence in response to determining that the query sentence does not include the key information to be clarified; generating at least one question to be clarified, and feeding back the at least one question to be clarified to the user in response to determining that the query sentence includes the at least one key information item to be clarified; and rewriting the query sentence based on a clarification result supplemented by the user for the at least one question to be clarified, to obtain a rewritten query sentence.

### CROSS-REFERENCE TO RELATED APPLICATION(S)

This application claims priority to Chinese Application No. 202510162064.X filed on February 13, 2025, the disclosure of which is incorporated herein by reference in its entity.

### FIELD

The present disclosure relates to the field of computer technologies, and in particular, to a method for implementing intelligent conversation reverse question clarification and a related device.

### BACKGROUND

At present, natural language processing is one of the most important branches in the field of artificial intelligence, and intelligent conversation is one of the most classic application scenarios in the field of natural language processing and is also one of the most commonly used means of human-computer interaction. An intelligent conversation may understand a user question described in a natural language and generate reply content containing an answer or perform a task assigned by the user. Reverse question clarification is a common conversation strategy, which may help an intelligent conversation system understand user intentions more accurately.

### SUMMARY

In view of this, embodiments of the present disclosure provide a method for implementing intelligent conversation reverse question clarification and a related device.

The method for implementing intelligent conversation reverse question clarification described in embodiments of the present disclosure may include: receiving a query sentence input by a user; identifying key information to be clarified in the query sentence based on a preset candidate indicator set, and determining a candidate indicator corresponding to the key information to be clarified; outputting the query sentence in response to determining that the query sentence does not include the key information to be clarified; generating at least one question to be clarified based on the at least one key information item to be clarified and the candidate indicator corresponding to the key information to be clarified, and feeding back the at least one question to be clarified to the user in response to determining that the query sentence includes at least one key information item to be clarified; and rewriting the query sentence based on a clarification result supplemented by the user for the at least one question to be clarified, and outputting a rewritten query sentence.

In some embodiments of the present disclosure, identifying the key information to be clarified in the query sentence based on the preset candidate indicator set and determining the candidate indicator corresponding to the key information to be clarified includes: determining at least one key information item in the query sentence input by the user; and determining whether the at least one key information item is the key information to be clarified based on the preset candidate indicator set, where the key information to be clarified includes: key information for which a corresponding candidate indicator cannot be found in the preset candidate indicator set, and/or key information for which a plurality of corresponding candidate indicators are found in the preset candidate indicator set; and determining a corresponding candidate indicator for the key information determined to be the key information to be clarified, where for the key information to be clarified for which a corresponding candidate indicator cannot be found in the preset candidate indicator set, the corresponding candidate indicator is determined as an empty set.

In some embodiments of the present disclosure, generating the at least one question to be clarified based on the at least one key information item to be clarified and the candidate indicator corresponding to the key information includes: determining whether the key information corresponds to a plurality of candidate indicators; and obtaining an information mapping group of the key information and the plurality of candidate indicators by acquiring the plurality of candidate indicators corresponding to the key information in response to determining that the key information corresponds to the plurality of candidate indicators, generating the question to be clarified based on the key information in the information mapping group, and generating a checkbox including a plurality of options based on the plurality of candidate indicators in the information mapping group; and generating the question to be clarified based on the key information and generating an input box for the user to input a clarification result in response to determining that the candidate indicator corresponding to the key information is an empty set.

Some embodiments of the present disclosure further include: in response to generating the checkbox including the plurality of options based on the plurality of candidate indicators in the information mapping group, generating an input box for the user to input a clarification result.

In some embodiments of the present disclosure, rewriting the query sentence based on the clarification result supplemented by the user for the at least one question to be clarified includes: obtain at least one clarification result information pair composed of the key information to be clarified and the clarification result by separately acquiring a clarification result for each key information item to be clarified; and obtaining the rewritten query sentence by inputting the query sentence and the at least one clarification result information pair into a large language model, and rewriting, by the large language model, the query sentence based on the at least one clarification result information pair.

Some embodiments of the present disclosure further include: searching stored general knowledge and/or historical information for auxiliary information matching the query sentence input by the user, before identifying the key information to be clarified in the query sentence based on a pre-trained query sentence understanding model; and rewriting the query sentence based on the auxiliary information.

In some embodiments of the present disclosure, rewriting the query sentence based on the auxiliary information includes: inputting the query sentence and the auxiliary information into a large language model, and completing the rewriting of the query sentence by the large language model.

Some embodiments of the present disclosure further include: storing an obtained clarification result information pair composed of the key information to be clarified and the clarification result as the historical information, after obtaining the clarification result supplemented by the user for the at least one question to be clarified.

Some embodiments of the present disclosure further include: returning to a step of identifying the key information to be clarified in the query sentence based on a pre-trained query sentence understanding model, after obtaining the rewritten query sentence.

Some embodiments of the present disclosure further include: initializing a clarification number parameter to 0; increasing the clarification number parameter by 1 after obtaining the rewritten query sentence; determining whether the clarification number parameter reaches a preset reverse question clarification target round; and returning to a step of identifying the key information to be clarified in the query sentence based on a pre-trained query sentence understanding model in response to determining that the reverse question clarification target round is not reached; or outputting the rewritten query sentence, in response to determining that the reverse question clarification target round is reached.

Corresponding to the method for implementing intelligent conversation reverse question clarification, some embodiments of the present disclosure further disclose an apparatus for implementing intelligent conversation reverse question clarification, including:

a user interface module, configured to receive a query sentence input by a user;

a query sentence understanding module, configured to identify key information to be clarified in the query sentence based on a preset candidate indicator set and determine a candidate indicator corresponding to the key information to be clarified;

an output module, configured to output the query sentence in response to determining that the query sentence does not include the key information to be clarified;

a reverse question clarification module, configured to generate at least one question to be clarified based on the at least one key information item to be clarified and the candidate indicator corresponding to the key information, and feed back the at least one question to be clarified to the user in response to determining that the query sentence includes the at least one key information item to be clarified; and

a rewriting module, configured to rewrite the query sentence based on a clarification result supplemented by the user for the at least one question to be clarified, and output a rewritten query sentence.

The apparatus for implementing intelligent conversation reverse question clarification according to some embodiments of the present disclosure further includes: a pre-rewriting module, configured to, before inputting the query sentence output by the user interface module into the query sentence understanding module, search stored general knowledge and/or historical information for auxiliary information matching the query sentence input by the user, and rewrite the query sentence based on the auxiliary information.

In addition, an embodiment of the present disclosure further provides an electronic device, including: a memory, a processor, and a computer program stored on the memory and executable on the processor, where the processor, when executing the computer program, implements the method for implementing intelligent conversation reverse question clarification.

An embodiment of the present disclosure further provides a non-transitory computer-readable storage medium, storing computer instructions, where the computer instructions are used to cause a computer to perform the method for implementing intelligent conversation reverse question clarification.

An embodiment of the present disclosure further provides a computer program product, including computer program instructions that, when executed on a computer, cause the computer to perform the method for implementing intelligent conversation reverse question clarification.

### BRIEF DESCRIPTION OF THE DRAWINGS

To describe the technical solutions in the present disclosure or in the related art more clearly, the following briefly introduces the drawings required for describing the embodiments or the related art. Apparently, the drawings in the following description show merely some embodiments of the present disclosure, and a person of ordinary skill in the art may still derive other drawings from these drawings without creative efforts.

FIG. 1 shows a procedure of implementing a method for implementing intelligent conversation reverse question clarification according to some embodiments of the present disclosure.

FIG. 2 shows a procedure of a method for identifying key information to be clarified in a query sentence based on a preset candidate indicator set and determining a candidate indicator corresponding to the key information to be clarified according to an embodiment of the present disclosure.

FIG. 3 shows a procedure of a method for separately generating a question to be clarified for each key information item to be clarified according to an embodiment of the present disclosure.

FIG. 4 shows an example of a generated question to be clarified according to an embodiment of the present disclosure.

FIG. 5 shows a procedure of a method for rewriting a query sentence based on a clarification result supplemented by a user for at least one question to be clarified according to an embodiment of the present disclosure.

FIG. 6 shows a procedure of a method for rewriting a query sentence based on stored general knowledge and/or historical information according to an embodiment of the present disclosure.

FIG. 7 shows an internal structure of an apparatus for implementing intelligent conversation reverse question clarification according to some embodiments of the present disclosure.

FIG. 8 shows a schematic diagram of a more specific hardware structure of an electronic device according to some embodiments of the present disclosure.

### DETAILED DESCRIPTION OF EMBODIMENTS

In order to make the objects, technical solutions and advantages of the present disclosure clearer, the present disclosure will be further described in detail below in combination with specific embodiments and with reference to the drawings.

It should be noted that unless otherwise defined, the technical or scientific terms used in the embodiments of the present disclosure should have the usual meanings as understood by those of ordinary skill in the art to which the present disclosure belongs. The terms such as "first" and "second" used in the embodiments of the present disclosure do not indicate any order, quantity or importance, but are only used to distinguish different components. The terms such as "include/comprise" or "including/including" and the like mean that the elements or objects appearing before the terms include the elements or objects listed after the terms and their equivalents, without excluding other elements or objects. The terms such as "connect/connected" or "couple/coupled" are not limited to physical or mechanical connections, but may include electrical connections, whether direct or indirect. The terms such as "on", "under", "left" and "right" are only used to indicate relative positional relationships, and when the absolute position of the described object changes, the relative positional relationships may also change accordingly.

It may be understood that before using the technical solutions in the embodiments of the present disclosure, the user will be informed of the type, range of use, use scenarios, etc. of the involved personal information in an appropriate manner, and the authorization of the user will be obtained.

For example, in response to receiving an active request from a user, prompt information is sent to the user to clearly inform the user that the requested operation will require access to and use of personal information of the user. In this way, the user may independently choose whether to provide the personal information to software or hardware, such as an electronic device, an application, a server or a storage medium, that performs the operations of the technical solutions of the present disclosure based on the prompt information.

As an optional but non-limiting implementation, in response to receiving the active request from the user, the prompt information may be sent to the user in the form of, for example, a pop-up window, and the prompt information may be presented in the pop-up window in text. In addition, the pop-up window may also include a selection control for the user to choose whether to "agree" or "disagree" to provide the personal information to the electronic device.

It may be understood that the above process of notifying and acquiring user authorization is only illustrative and does not limit the implementations of the present disclosure, and other methods that satisfy relevant laws and regulations may also be applied to the implementations of the present disclosure.

As mentioned above, the existing intelligent conversation systems lack the capability of reverse question clarification, resulting in poor intelligent conversation effects. To this end, embodiments of the present disclosure provide a method for implementing intelligent conversation reverse question clarification, which is performed by an intelligent conversation system and may provide the intelligent conversation system with the capability of reverse question clarification, thereby improving the intelligent conversation effect of the intelligent conversation system.

Existing intelligent conversation systems often lack the capability of reverse question clarification, resulting in poor intelligent conversation effects.

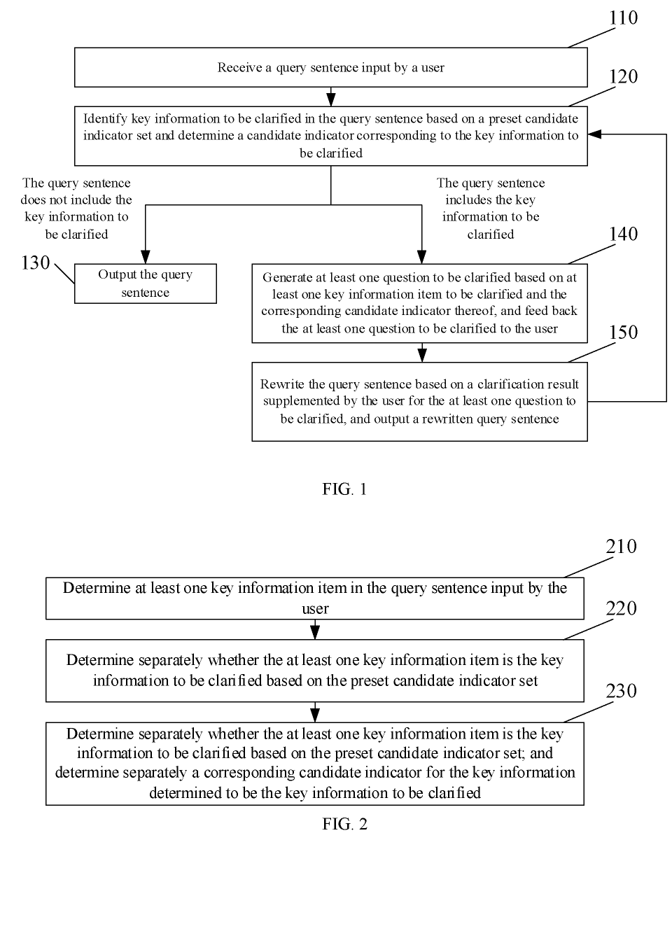

FIG. 1 shows a procedure of implementing a method for implementing intelligent conversation reverse question clarification according to some embodiments of the present disclosure. As shown in FIG. 1, the method for implementing intelligent conversation reverse question clarification according to embodiments of the present disclosure includes the following steps.

At step 110, a query sentence input by a user is received.

At step 120, key information to be clarified in the query sentence is identified based on a preset candidate indicator set and a candidate indicator corresponding to the key information to be clarified is determined.

At step 130, the query sentence is output in response to determining that the query sentence does not include the key information to be clarified.

At step 140, at least one question to be clarified is generated based on the at least one key information item to be clarified and the corresponding candidate indicator thereof, and the at least one question to be clarified is fed back to the user, in response to determining that the query sentence includes at least one key information item to be clarified.

At step 150, the query sentence is rewritten based on a clarification result supplemented by the user for the at least one question to be clarified, and a rewritten query sentence is output.

It should be noted that in an embodiment of the present disclosure, after the above step 150 is performed, the method goes back to step 120 to continue to perform the next round of reverse question clarification identification and rewriting of the query sentence, until it is determined that the query sentence no longer includes the key information to be clarified.

In addition, as an alternative to the above solution, a reverse question clarification target round, such as 3 or 5 times, may also be set in advance. In addition, before the above method is performed, a clarification number parameter is initialized and its value is set to 0. After the above step 150 is performed, the clarification number parameter is increased by 1 to record the number of rounds of query sentence rewriting that have been performed. Before the method goes back to the above step 120, it is determined whether the value of the clarification number parameter reaches the preset reverse question clarification target round. In response to determining that the preset reverse question clarification target round is not reached, the method goes back to the above step 120 to perform the next round of reverse question clarification identification and rewriting of the query sentence; and in response to determining that the preset reverse question clarification target round is reached, the rewritten query sentence in the current round may be output. It may be seen that in the above embodiment, the purpose of setting the reverse question clarification target round is to limit the maximum number of rounds of reverse question clarification, thereby improving the efficiency and effectiveness of reverse question clarification, and avoiding excessive reverse question clarification to the user, which affects the user's conversation experience.

In addition, in the above method for implementing intelligent conversation reverse question clarification, when outputting the query sentence input by the user or the rewritten query sentence, the query sentence may be first converted into a domain specific language (DSL) and then output.

The following further describes each step of the above method for implementing intelligent conversation reverse question clarification in detail with reference to specific examples.

In the above step 110, the query sentence input by the user usually refers to a question or task actually input by the user. In the field of intelligent conversation, the query sentence is also referred to as a Query. In general, the query sentence or Query input by the user may contain some vague or ambiguous semantics. Therefore, if the query sentence input by the user is directly used for information recall, a large amount of inaccurate information may be obtained, which reduces the accuracy of intelligent conversation output and causes a poor user conversation experience. Therefore, in the case where the semantics expressed by the user is unclear, reverse question clarification may be performed to clarify the user's intention.

For the above step 120, in an embodiment of the present disclosure, the preset candidate indicator set usually includes several preset candidate indicators. These candidate indicators usually represent expressions with clear meanings of key information that users care about in some specific business fields, that is, standard names of indicators that users usually care about in some specific business fields. For example, in the field of e-commerce, candidate indicators related to the number of people may include: the number of people who made a deal, the number of people who requested a refund, the number of people who made a payment, and the like. For another example, in the field of e-commerce, candidate indicators related to an amount of money may include: a transaction amount, a refund amount, a payment amount, and the like. Taking the preset candidate indicator set above as a reference may assist in identifying whether the query sentence input by the user includes the key information to be clarified, that is, whether the semantics of the query sentence input by the user is clear may be determined.

Specifically, FIG. 2 shows a method for identifying key information to be clarified in a query sentence based on a preset candidate indicator set and determining a candidate indicator corresponding to the key information to be clarified according to an embodiment of the present disclosure. That is, FIG. 2 shows a method for implementing the above step 120. As shown in FIG. 2, the above step 120 may include the following steps.

At step 210, at least one key information item in the query sentence input by the user is determined.

It may be understood that not all content in the query sentence input by the user contains key information, and therefore, in order to help a computer understand the content of the user's query and find relevant information in a database or information resource, it is very important to extract the key information from the query sentence. In general, the key information extraction from the query sentence is an important application of natural language processing (NLP) and may be implemented through NLP technology.

At step 220, whether the at least one key information item is the key information to be clarified is separately determined based on the preset candidate indicator set.

Specifically, in an embodiment of the present disclosure, the key information to be clarified may usually include: key information for which a corresponding candidate indicator cannot be found in the preset candidate indicator set; and/or key information for which a plurality of corresponding candidate indicators are found in the preset candidate indicator set.

For example, the query sentence input by the user is "how is the data market overview tonight". Among them, it may be learned by understanding the query sentence that one key information item in the query sentence is "market overview". If a candidate indicator corresponding to the "market overview" cannot be found in the preset candidate indicator set, the "market overview" belongs to the key information to be clarified. In this case, reverse question clarification is required, and the user is asked to supplement what specific indicator the "market overview" refers to. For another example, the query sentence input by the user is "query the amount in the last three months". Among them, it may be learned by understanding the query sentence that one key information item in the query sentence is "amount". If a plurality of candidate indicators corresponding to the "amount" may be found in the preset candidate indicator set, for example, including: "transaction amount", "refund amount", "sales amount", and the like, the "amount" also belongs to the key information to be clarified. In this case, reverse question clarification is also required, and the user is asked to select a target candidate indicator corresponding to the "amount" from the plurality of corresponding indicators. For another example, the query sentence input by the user is "query the sales amount in the last three months". Among them, it may be learned by understanding the query sentence that one key information item in the query sentence is "sales amount", or the user is asked to supplement what specific indicator the "amount" refers to. If there is one and only one candidate indicator corresponding to the "sales amount" in the preset candidate indicator set, that is, the "sales amount" itself, it indicates that the key information in the query sentence has a clear meaning, and therefore reverse question clarification is not required.

At step 230, a corresponding candidate indicator is determined for the key information determined to be the key information to be clarified.

Specifically, in an embodiment of the present disclosure, for the key information to be clarified for which a corresponding candidate indicator cannot be found in the preset candidate indicator set, it may be determined that the corresponding candidate indicator is an empty set; and for the key information to be clarified for which a plurality of corresponding candidate indicators are found in the preset candidate indicator set, it may be determined that the corresponding candidate indicators are the plurality of corresponding candidate indicators found.

In some embodiments of the present disclosure, the method shown in FIG. 2 may be implemented by a trained query sentence understanding model. The query sentence understanding model may be a specially trained large language model, which is mainly configured to identify the key information to be clarified in the query sentence based on the preset candidate indicator set. In these embodiments, the advantage of the large language model in natural language understanding may be used to identify and analyze the key information in the query sentence, so that the key information to be clarified in the query sentence may be accurately identified.

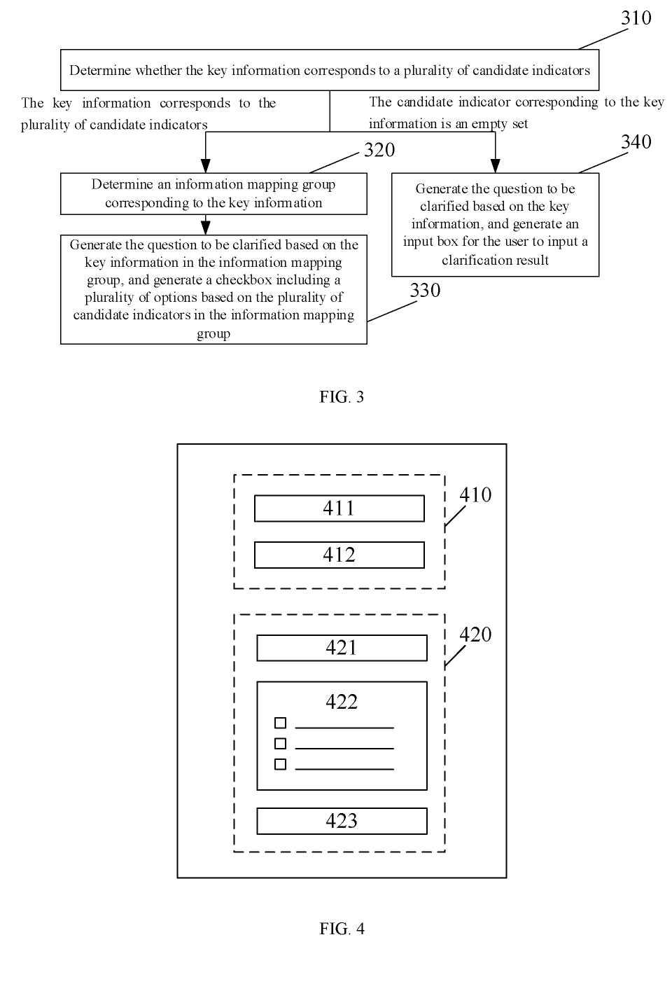

For the above step 140, in some embodiments of the present disclosure, FIG. 3 shows a procedure of a method for separately generating a question to be clarified for each key information item to be clarified according to an embodiment of the present disclosure. As shown in FIG. 3, the method for generating the question to be clarified for each key information item to be clarified may specifically perform the following steps.

At step 310, whether the key information corresponds to a plurality of candidate indicators is determined.

At step 320, an information mapping group corresponding to the key information is determined in response to determining that the key information corresponds to the plurality of candidate indicators.

Among them, the above information mapping group includes a mapping relationship of key information-candidate indicator.

At step 330, the question to be clarified is generated based on the key information in the above information mapping group, and a checkbox including a plurality of options is generated based on the plurality of candidate indicators in the above information mapping group.

At the above step 330, in addition to the above checkbox, an input box for the user to input a clarification result may be further generated to adapt to the case where all candidate indicators do not meet the user's needs.

At step 340, a question to be clarified is generated based on the above key information, and an input box for the user to input a clarification result is generated in response to determining that the candidate indicator corresponding to the above key information is an empty set.

Based on the foregoing example, it is assumed that the key information to be clarified in the query sentence obtained by the query sentence understanding model is the "market overview". Since no corresponding candidate indicator for the "market overview" may be found in the preset candidate indicator set, the question to be clarified "what does the 'market overview' represent:" may be generated based on the key information to be clarified being the "market overview" in the above step 340. In addition, the input box for the user to input the clarification result is generated. For another example, it is assumed that the key information to be clarified in the query sentence obtained by the query sentence understanding model is the "amount". Since the "amount" corresponds to a plurality of candidate indicators: the transaction amount, the refund amount, and the sales amount, the question to be clarified "what does the 'amount' represent" may be generated based on the key information to be clarified being the "amount" in the above step 330. Further, in the above step 330, a checkbox including three options of the "transaction amount", the "refund amount", and the "sales amount" is generated based on the "amount" corresponding to the plurality of candidate indicators: the "transaction amount", the "refund amount", and the "sales amount". Furthermore, the input box for the user to input the clarification result is also generated.

FIG. 4 shows an example of a generated question to be clarified according to an embodiment of the present disclosure. The example shown in FIG. 4 includes two questions to be clarified: question 410 and question 420. Question 410 includes: content 411 of question 410 and an input box 412 for the user to input a clarification result; and question 420 includes: content 421 of question 420, a checkbox 422 for the user to select a clarification result, and an input box 423 for the user to input a clarification result.

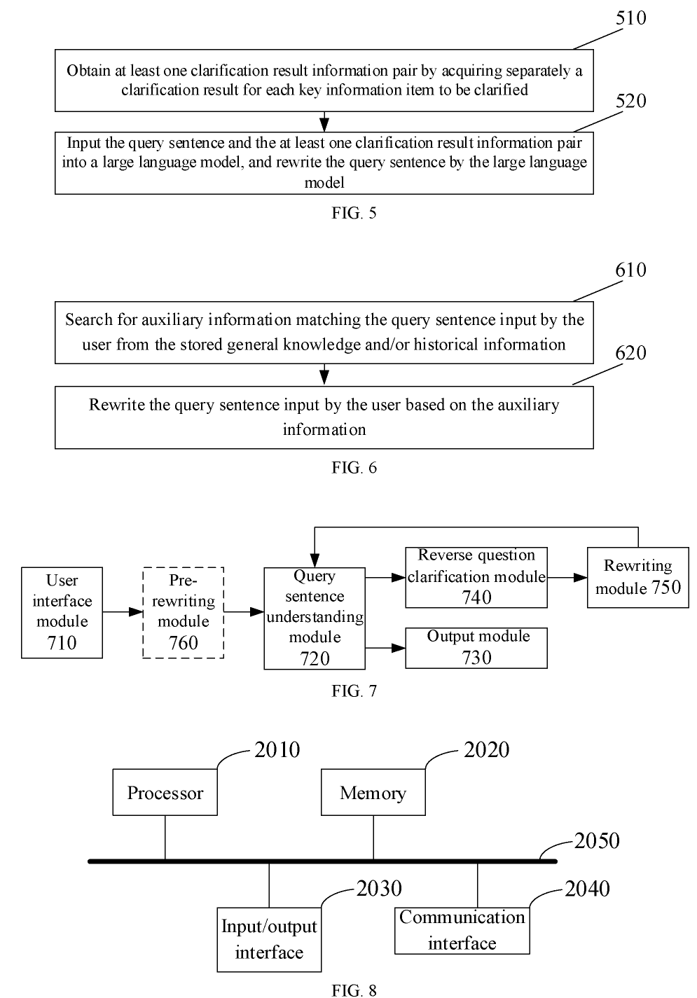

For the above step 150, FIG. 5 shows a procedure of a method for rewriting a query sentence based on a clarification result supplemented by a user for at least one question to be clarified according to an embodiment of the present disclosure. As shown in FIG. 5, the method for rewriting the query sentence may specifically include the following steps.

At step 510, a clarification result for each key information item to be clarified is separately acquired to obtain at least one clarification result information pair composed of the key information to be clarified and the clarification result.

At step 520, the query sentence and the at least one clarification result information pair are input into a large language model, and the query sentence is rewritten by the large language model based on the at least one clarification result information pair to obtain the rewritten query sentence.

In the above embodiment, the advantage of the large language model in natural language processing may be used to rewrite the key information to be clarified in the query sentence based on the input clarification result information pair, so that the key information with vague semantics in the query sentence may be rewritten into a more accurate expression.

Based on the foregoing example, it is assumed that for the key information "amount" to be clarified, the candidate indicator corresponding to the "amount" selected by the user in the checkbox is the "transaction amount", and a clarification result information pair of "amount"-"transaction amount" is established in the above step 510. Then, in the above step 520, the query sentence "query the amount in the last three months" and the clarification result information pair "amount"-"transaction amount" are input into the large language model, and the query sentence is rewritten by the large language model, so that the rewritten query sentence "query the transaction amount in the last three months" may be obtained. It may be seen that the semantics of the rewritten query sentence is clearer. In this way, more accurate results may be obtained by performing information recall with the modified query sentence, thereby greatly improving the efficiency and effectiveness of intelligent conversation and improving the user's conversation experience.

It may be seen that in an embodiment of the present disclosure, for the query sentence input by the user, the key information to be clarified in the query sentence and the corresponding candidate indicator may be first identified based on the query sentence understanding model, and the question to be clarified may be generated based on identified information. Then, after obtaining the clarification result supplemented by the user for the question to be clarified, the query sentence is rewritten based on the obtained clarification result, thereby providing the intelligent conversation system with an efficient reverse question clarification capability and improving the effect of intelligent conversation.

In order to further enhance the implementation effect of reverse question clarification, before the above step 120 of identifying the key information to be clarified in the query sentence based on the pre-trained query sentence understanding model is performed, an embodiment of the present disclosure may further include: rewriting the query sentence based on stored general knowledge and/or historical information to obtain a rewritten query sentence.

Specifically, FIG. 6 shows a procedure of a method for rewriting a query sentence based on stored general knowledge and/or historical information according to an embodiment of the present disclosure. As shown in FIG. 6, the method for rewriting the query sentence may specifically include the following steps.

At step 610, auxiliary information matching the query sentence input by the user is searched for from the stored general knowledge and/or historical information.

At step 620, the query sentence input by the user is rewritten based on the above auxiliary information.

Specifically, in an embodiment of the present disclosure, the general knowledge may usually include public business knowledge such as a correspondence between a commonly-used saying (also referred to as an industry jargon) and a standard term in a specific business field, a question-answer data pair (also referred to as a QA pair) in the specific business field, and a document.

In an embodiment of the present disclosure, the historical information may include: user-related historical information stored by the intelligent conversation system. For example, the historical intelligent conversation information of the user and the clarification result submitted by the user historically for reverse question clarification are stored by the intelligent conversation system.

In this way, in the above step 610, based on a similarity matching policy, the auxiliary information having a high similarity with the query sentence input by the user may be acquired from the stored general knowledge and/or historical information. For example, in an application, one or more pieces of information whose similarity with the query sentence input by the user is greater than a preset threshold or one or more pieces of information with the highest similarity ranking may be recalled from the stored general knowledge and/or historical information by means of information recall as the auxiliary information.

After one or more pieces of auxiliary information are obtained, in the above step 620, the query sentence input by the user and the one or more pieces of auxiliary information may be input into the large language model, and the rewriting of the query sentence input by the user is completed by the large language model. It should be noted that the large language model may be the same as the large language model used in the above step 150.

In a specific example, it is assumed that the query sentence input by the user is "query the transaction situation in the last three months", and the general knowledge stores that the "transaction situation" is a commonly-used saying in a certain business field, and the corresponding standard term is the "transaction amount and the number of people who made a deal". In this way, it may be recalled from the general knowledge through the above step 610 that what corresponds to the "transaction situation" is the "transaction amount and the number of people who made a deal", and the recalled information is used as the auxiliary information. In this way, based on the auxiliary information, the large language model may modify the query sentence input by the user to "query the transaction amount and the number of people who made a deal in the last three months".

In another specific example, it is assumed that the query sentence input by the user is "what about last month". In this way, through the above step 610, the historical intelligent conversation information of the user stored by the intelligent conversation system may be queried with the query sentence, and the historical record "query the sales data for this month" that is close in time and has the highest similarity may be obtained as the auxiliary information. In this way, based on the auxiliary information, the large language model may modify the query sentence input by the user to "query the sales data for last month".

In yet another specific example, it is assumed that the query sentence input by the user is "query the amount in the last three months". In this way, through the above step 610, the historical clarification result submitted for reverse question clarification stored by the intelligent conversation system may be queried with the query sentence, and the clarification result information pair "amount"-"transaction amount" with the highest similarity obtained through reverse question clarification may be found as the auxiliary information. In this way, based on the auxiliary information, the large language model may modify the query sentence input by the user to "query the transaction amount in the last three months".

It may be seen that by performing the method of the above step 610 to step 620, the query sentence input by the user may be automatically rewritten in advance based on the general knowledge and the historical information before reverse question clarification is performed, so that the general knowledge and the historical information may be effectively used to automatically eliminate some content with vague semantics or ambiguity in the query sentence, thereby improving the quality and effectiveness of the query sentence, effectively reducing the number of key information that needs reverse question clarification or the number of rounds of reverse question clarification, improving the service efficiency of the intelligent conversation system, and improving the experience of the user in intelligent conversation.

It may be seen that in order to implement the method shown in FIG. 6, in some embodiments of the present disclosure, in the method shown in FIG. 1, after the clarification result supplemented by the user for the at least one question to be clarified is obtained, an obtained clarification result information pair composed of the key information to be clarified and the clarification result may be further stored. In this way, the clarification result information pair will be used as the historical information to implement automatic rewriting of the query sentence input by the user in a subsequent intelligent conversation process. The storing step may be performed before or after the above step 150, and the embodiments of the present disclosure are not limited thereto.

Corresponding to the method for implementing intelligent conversation reverse question clarification, some embodiments of the present disclosure further disclose an apparatus for implementing intelligent conversation reverse question clarification. FIG. 7 shows an internal structure of an apparatus for implementing intelligent conversation reverse question clarification according to some embodiments of the present disclosure. As shown in FIG. 7, the apparatus for implementing intelligent conversation reverse question clarification may include:

a user interface module 710, configured to receive a query sentence input by a user;

a query sentence understanding module 720, configured to identify key information to be clarified in the query sentence based on a preset candidate indicator set and determine a candidate indicator corresponding to the key information to be clarified;

an output module 730, configured to output the query sentence in response to determining that the query sentence does not include the key information to be clarified;

a reverse question clarification module 740, configured to generate at least one question to be clarified based on the at least one key information item to be clarified and the candidate indicator corresponding to the key information, and feed back at least one question to be clarified to the user in response to determining that the query sentence includes the at least one key information item to be clarified; and

a rewriting module 750, configured to rewrite the query sentence based on a clarification result supplemented by the user for the at least one question to be clarified, to obtain a rewritten query sentence.

Furthermore, in some embodiments of the present disclosure, the apparatus for implementing intelligent conversation reverse question clarification may further include: a pre-rewriting module 760, configured to, before inputting the query sentence output by the user interface module into the query sentence understanding module, search stored general knowledge and/or historical information for auxiliary information matching the query sentence input by the user, and rewrite the query sentence based on the auxiliary information.

It may be seen that with the apparatus for implementing intelligent conversation reverse question clarification, for the query sentence input by the user, the key information to be clarified in the query sentence and the corresponding candidate indicator may be first identified based on the query sentence understanding model, and the question to be clarified may be generated based on identified information. Then, after obtaining the clarification result supplemented by the user for the question to be clarified, the query sentence is rewritten based on the obtained clarification result, thereby providing the intelligent conversation system with the capability of reverse question clarification and improving the effect of intelligent conversation.

Based on the same inventive concept, corresponding to the method of any one of the above embodiments, the present disclosure further provides an electronic device, including: a memory, a processor, and a computer program stored on the memory and executable on the processor, where the processor, when executing the computer program, implements the method for implementing intelligent conversation reverse question clarification of any one of the above embodiments.

FIG. 8 shows a schematic diagram of a more specific hardware structure of an electronic device provided by this embodiment, and the electronic device may include: a processor 2010, a memory 2020, an input/output interface 2030, a communication interface 2040, and a bus 2050. The processor 2010, the memory 2020, the input/output interface 2030, and the communication interface 2040 are communicatively connected to each other within the electronic device through the bus 2050.

The processor 2010 may be implemented by a general-purpose central processing unit (CPU), a microprocessor, an application specific integrated circuit (ASIC), or one or more integrated circuits, etc. for executing related programs, to implement the technical solutions provided by the embodiments of the specification.

The memory 2020 may be implemented in the form of a read-only memory (ROM), a random access memory (RAM), a static storage device, a dynamic storage device, etc. The memory 2020 may store an operating system and other applications, and when implementing the technical solutions provided by the embodiments of the specification by means of software or firmware, the related program codes are stored in the memory 2020 and called by the processor 2010 for execution.

The input/output interface 2030 is configured to connect to an input/output device to enable information input and output. The input/output device may be configured as a component in the electronic device, or it may be external to the electronic device to provide a corresponding function. The input device may include a microphone, various sensors, etc., and the output device may include a display, a speaker, a vibrator, an indicator light, etc.

The communication interface 2040 is configured to connect to a communication module (not shown) to enable communication interaction between the electronic device and other devices. The communication module may communicate in a wired (e.g., a USB, a network cable, etc.), or wireless (e.g., a mobile network, Wi-Fi, Bluetooth, etc.) manner.

The bus 2050 includes a path for transferring information between components (for example, the processor 2010, the memory 2020, the input/output interface 2030, and the communication interface 2040) of the electronic device.

It should be noted that although only the processor 2010, the memory 2020, the input/output interface 2030, the communication interface 2040, and the bus 2050 are shown in the electronic device, during a specific implementation, the electronic device may further include other components necessary for proper operation. Furthermore, it may be understood by those skilled in the art that the electronic device may include only the components necessary to implement the solutions provided by the embodiments of the specification, and not necessarily include all of the components shown in the figure.

The electronic device of the above embodiment is configured to implement the corresponding method for implementing intelligent conversation reverse question clarification in any one of the above embodiments, and has the beneficial effects of the corresponding method embodiment, which are not repeated herein.

Based on the same inventive concept, corresponding to the method of any one of the above embodiments, the present disclosure further provides a non-transitory computer-readable storage medium, storing computer instructions, where the computer instructions are used to cause a computer to perform the method for implementing intelligent conversation reverse question clarification of any one of the above embodiments.

The computer-readable medium of this embodiment includes permanent and non-permanent, removable and non-removable media, and information storage may be implemented by using any method or technology. Information may be computer-readable instructions, data structures, modules of a program, or other data. Examples of the computer storage medium include, but are not limited to, a phase-change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette tape, tape or disk storage or another magnetic storage device, or any other non-transmission medium, which may be used to store information that may be accessed by a computing device.

The computer instructions stored on the storage medium of the above embodiment are used to cause the computer to perform the task processing method of any one of the above embodiments, and have the beneficial effects of the corresponding method embodiment, which are not repeated herein.

It should be understood by those of ordinary skill in the art that the discussion of any one of the above embodiments is merely exemplary, and is not intended to imply that the scope of the present disclosure (including the claims) is limited to these examples; and with the concept of the present disclosure, the technical features in the above embodiments or different embodiments may also be combined, steps may be implemented in any order, many other changes may be made to different aspects of the embodiments of the present disclosure as described above and are not provided in detail for simplicity.

In addition, to simplify description and discussion and avoid obscuring an understanding of an embodiment of the present disclosure, well-known power/ground connections to an integrated circuit (IC) chip and other components may or may not be shown in the drawings that are provided. Furthermore, the apparatus may be shown in the form of a block diagram to avoid obscuring an understanding of the embodiments of the present disclosure, and the following fact is also taken into account: details regarding the implementation of the apparatus in the form of block diagram are highly dependent upon a platform on which the embodiments of the present disclosure are to be implemented (i.e., such details should be fully understood by those skilled in the art). Where the specific details (e.g., circuitry) are set forth to describe the exemplary embodiments of the present disclosure, it will be apparent to those skilled in the art that the embodiments of the present disclosure may be implemented without these specific details or with variations to these specific details. These descriptions should therefore be considered illustrative rather than limiting.

Although the present disclosure has been described with reference to the specific embodiments of the present disclosure, many substitutions, modifications, and variations of these embodiments will be apparent to those of ordinary skill in the art from the foregoing description. For example, the discussed embodiments may be used for other memory architectures such as a dynamic RAM (DRAM).

The embodiments of the present disclosure are intended to cover all such substitutions, modifications, and variations that fall within the broad scope of the appended claims. Therefore, any omissions, modifications, equivalent substitutions, improvements etc. made within the spirit and principle of the embodiments of the present disclosure are intended to be included within the scope of protection of the present disclosure.

We claim:

1. A method for implementing intelligent conversation reverse question clarification, comprising:
receiving a query sentence input by a user;
identifying key information to be clarified in the query sentence based on a preset candidate indicator set and determining a candidate indicator corresponding to the key information to be clarified;
outputting the query sentence in response to determining that the query sentence does not comprise the key information to be clarified;
generating at least one question to be clarified based on at least one key information item to be clarified and the candidate indicator corresponding to the key information, and feeding back the at least one question to be clarified to the user, in response to determining that the query sentence comprises the at least one key information item to be clarified; and
rewriting the query sentence based on a clarification result supplemented by the user for the at least one question to be clarified, and outputting a rewritten query sentence.

2. The method of claim 1, wherein identifying the key information to be clarified in the query sentence based on the preset candidate indicator set and determining the candidate indicator corresponding to the key information to be clarified comprises:
determining at least one key information item in the query sentence input by the user;
determining whether the at least one key information item is the key information to be clarified based on the preset candidate indicator set; wherein, the key information to be clarified comprises: key information for which a corresponding candidate indicator cannot be found in the preset candidate indicator set, and/or key information for which a plurality of corresponding candidate indicators are found in the preset candidate indicator set; and
determining a corresponding candidate indicator for the key information determined to be the key information to be clarified; wherein, for the key information to be clarified for which a corresponding candidate indicator cannot be found in the preset candidate indicator set, the corresponding candidate indicator is determined as an empty set.

3. The method of claim 2, wherein generating the at least one question to be clarified based on the at least one key information item to be clarified and the candidate indicator corresponding to the key information comprises:
determining whether the key information corresponds to a plurality of candidate indicators;
obtaining an information mapping group of the key information and the plurality of candidate indicators by acquiring the plurality of candidate indicators corresponding to the key information in response to determining that the key information corresponds to the plurality of candidate indicators, generating the question to be clarified based on the key information in the information mapping group, and generating a checkbox comprising a plurality of options based on the plurality of candidate indicators in the information mapping group; and
generating the question to be clarified based on the key information and generating an input box for the user to input a clarification result, in response to determining that the candidate indicator corresponding to the key information is an empty set.

4. The method of claim 3, further comprising: in response to generating the checkbox comprising the plurality of options based on the plurality of candidate indicators in the information mapping group, generating an input box for the user to input the clarification result.

5. The method of claim 1, wherein, rewriting the query sentence based on the clarification result supplemented by the user for the at least one question to be clarified comprises:
obtaining at least one clarification result information pair composed of the key information to be clarified and a clarification result by separately acquiring the clarification result for each key information item to be clarified; and
obtaining the rewritten query sentence by inputting the query sentence and the at least one clarification result information pair into a large language model, and rewriting, by the large language model, the query sentence based on the at least one clarification result information pair.

6. The method of claim 1, further comprising:
searching stored general knowledge and/or historical information for auxiliary information matching the query sentence input by the user, before identifying the key information to be clarified in the query sentence based on a pre-trained query sentence understanding model; and
rewriting the query sentence based on the auxiliary information.

7. The method of claim 6, wherein, rewriting the query sentence based on the auxiliary information comprises: inputting the query sentence and the auxiliary information into a large language model, and completing the rewriting of the query sentence by the large language model.

8. The method of claim 7, further comprising: storing an obtained clarification result information pair composed of the key information to be clarified and the clarification result as the historical information, after obtaining the clarification result supplemented by the user for the at least one question to be clarified.

9. The method of claim 1, further comprising: returning to a step of identifying the key information to be clarified in the query sentence based on a pre-trained query sentence understanding model, after obtaining the rewritten query sentence.

10. The method of claim 1, further comprising:
initializing a clarification number parameter to 0;
increasing the clarification number parameter by 1 after obtaining the rewritten query sentence;
determining whether the clarification number parameter reaches a preset reverse question clarification target round;
returning to a step of identifying the key information to be clarified in the query sentence based on a pre-trained query sentence understanding model, in response to determining that the reverse question clarification target round is not reached; and
outputting the rewritten query sentence, in response to determining that the reverse question clarification target round is reached.

11. An electronic device, comprising:
a memory, a processor, and a computer program stored on the memory and executable on the processor, wherein the computer program, when executed by the processor, causes the processor to:
receive a query sentence input by a user;
identify key information to be clarified in the query sentence based on a preset candidate indicator set and determine a candidate indicator corresponding to the key information to be clarified;
output the query sentence in response to determining that the query sentence does not comprise the key information to be clarified;
generate at least one question to be clarified based on at least one key information item to be clarified and the candidate indicator corresponding to the key information, and feed back the at least one question to be clarified to the user, in response to determining that the query sentence comprises the at least one key information item to be clarified; and
rewrite the query sentence based on a clarification result supplemented by the user for the at least one question to be clarified, and output a rewritten query sentence.

12. The electronic device of claim 11, wherein the computer program causing the processor to identify the key information to be clarified in the query sentence based on the preset candidate indicator set and determine the candidate indicator corresponding to the key information to be clarified comprises instructions to:
determine at least one key information item in the query sentence input by the user;
determine whether the at least one key information item is the key information to be clarified based on the preset candidate indicator set; wherein, the key information to be clarified comprises: key information for which a corresponding candidate indicator cannot be found in the preset candidate indicator set, and/or key information for which a plurality of corresponding candidate indicators are found in the preset candidate indicator set; and
determine a corresponding candidate indicator for the key information determined to be the key information to be clarified; wherein, for the key information to be clarified for which a corresponding candidate indicator cannot be found in the preset candidate indicator set, the corresponding candidate indicator is determined as an empty set.

13. The electronic device of claim 12, wherein the computer program causing the processor to generate the at least one question to be clarified based on the at least one key information item to be clarified and the candidate indicator corresponding to the key information comprises instructions to:
determine whether the key information corresponds to a plurality of candidate indicators;
obtain an information mapping group of the key information and the plurality of candidate indicators by acquiring the plurality of candidate indicators corresponding to the key information in response to determining that the key information corresponds to the plurality of candidate indicators, generate the question to be clarified based on the key information in the information mapping group, and generate a checkbox comprising a plurality of options based on the plurality of candidate indicators in the information mapping group; and
generate the question to be clarified based on the key information and generating an input box for the user to input a clarification result, in response to determining that the candidate indicator corresponding to the key information is an empty set.

14. The electronic device of claim 13, wherein the computer program further comprises instructions to:
generate an input box for the user to input the clarification result, in response to generating the checkbox comprising the plurality of options based on the plurality of candidate indicators in the information mapping group.

15. The electronic device of claim 11, wherein the computer program causing the processor to rewrite the query sentence based on the clarification result supplemented by the user for the at least one question to be clarified comprises instructions to:
obtain at least one clarification result information pair composed of the key information to be clarified and a clarification result by separately acquiring the clarification result for each key information item to be clarified; and
obtain the rewritten query sentence by inputting the query sentence and the at least one clarification result information pair into a large language model, and rewrite, by the large language model, the query sentence based on the at least one clarification result information pair.

16. The electronic device of claim 11, wherein the computer program further comprises instructions to:
search stored general knowledge and/or historical information for auxiliary information matching the query sentence input by the user, before identifying the key information to be clarified in the query sentence based on a pre-trained query sentence understanding model; and
rewrite the query sentence based on the auxiliary information.

17. The electronic device of claim 16, wherein the computer program causing the processor to rewrite the query sentence based on the auxiliary information comprises instructions to:
input the query sentence and the auxiliary information into a large language model, and completing the rewriting of the query sentence by the large language model.

18. The electronic device of claim 17, wherein the computer program further comprises instructions to:
store an obtained clarification result information pair composed of the key information to be clarified and the clarification result as the historical information, after obtaining the clarification result supplemented by the user for the at least one question to be clarified.

19. The electronic device of claim 11, wherein the computer program further comprises instructions to:
return to a step of identifying the key information to be clarified in the query sentence based on a pre-trained query sentence understanding model, after obtaining the rewritten query sentence.

20. A non-transitory computer-readable storage medium, storing computer instructions, wherein the computer instructions are used to cause a computer to:
receive a query sentence input by a user;
identify key information to be clarified in the query sentence based on a preset candidate indicator set and determine a candidate indicator corresponding to the key information to be clarified;
output the query sentence in response to determining that the query sentence does not comprise the key information to be clarified;
generate at least one question to be clarified based on at least one key information item to be clarified and the candidate indicator corresponding to the key information, and feed back the at least one question to be clarified to the user, in response to determining that the query sentence comprises the at least one key information item to be clarified; and
rewrite the query sentence based on a clarification result supplemented by the user for the at least one question to be clarified, and output a rewritten query sentence.
